(19) United States
(12) Patent Application Publication
(10) Pub. No.: US 2023/0375903 A1
(43) Pub. Date: Nov. 23, 2023

(54) ELECTRONIC DEVICE, PHOTOGRAPHING METHOD AND DEVICE FOR ELECTRONIC DEVICE

(71) Applicant: SAMSUNG ELECTRONICS CO., LTD., SUWON-SI (KR)

(72) Inventor: Tiefeng LIU, Suwon-si (KR)

(21) Appl. No.: 17/872,060

(22) Filed: Jul. 25, 2022

(30) Foreign Application Priority Data
May 18, 2022 (CN) 202210547561.8

(51) Int. Cl. G03B 17/17; H04N 5/232; H04N 5/225

(52) U.S. Cl. CPC G03B 17/17; H04N 5/23245; H04N 5/2251

(57) ABSTRACT

The disclosure provides an electronic device and operating method of the same. The electronic device includes a first side, a second side opposite the first side, and a camera disposed on the first side; a glass member including a reflection area, wherein the reflection area includes a first reflection plate and a second reflection plate; and a processor configured to control the glass member to switch between a default position and an extended position, wherein when the glass member is in the default position, light incident on the camera from the first side passes through the reflection area to the camera, and when the glass member is in the extended position, the reflection area forms a periscope with the first reflection plate and the second reflection plate to redirect light from the second side to the camera.

### CROSS-REFERENCE TO RELATED APPLICATION

This application claims priority under 35 U.S.C. § 119 to Chinese patent application No. 202210547561.8, filed on May 18, 2022, the disclosure of which is incorporated by reference herein in its entirety.

### TECHNICAL FIELD

The present disclosure relates to a smart device. More particularly, the present disclosure relates to an electronic device and a method of photographing using the same.

### DISCUSSION OF THE RELATED ART

Recently, personal electronic devices such as mobile devices and smart phones have included a camera and lens assembly, so that a user may take photos without the need to bring a dedicated camera. Sometimes, a user wishes to take a photo of something facing the back of the phone, such as a landscape. Other times, a user wants to take a photo of something facing the front of the phone, such as a “selfie” photo. Typically, this requires both a front camera and a rear camera to be disposed on the device, or one camera that is folded back and forth by using a mechanical device. There is a need in the art for a camera system that allows a user to take photos facing forwards or backwards, without requiring separate cameras, or rotating or folding parts that are prone to mechanical failure.

### SUMMARY

Embodiments of the present disclosure include an electronic device, and a photographing method using the electronic device, which allow a user to take photos in both the front and rear directions of the electronic device with one camera of the electronic device by adopting a periscope arrangement structure.

According to the embodiments of the present disclosure, an electronic device includes: a first side, and a second side opposite the first side; a camera disposed on the first side; a glass member comprising a reflection area, wherein the reflection area comprises a first reflection plate and a second reflection plate; and a processor configured to control the glass member to switch between a default position and an extended position, wherein, when the glass member is in the default position, light incident on the camera from the first side passes through the reflection area to the camera; and when the glass member is in the extended position, light incident the camera from the first side is blocked by the reflection area, and the reflection area forms a periscope with the first reflection plate and the second reflection plate to redirect light from the second side to the camera.

The glass member may further include a transmission area.

When glass member is in the default position, the light in front of the camera may be incident to the camera through the transmission area.

The reflection area may include an opaque coating to block light in front of the camera.

When the glass member is in the extended position, the light behind the camera is incident to the camera by the reflection of the first reflection plate and the second reflection plate.

The electronic device may further include a driving member for driving the glass member to move according to the control of the processor so that the glass member switches between the default position and the extended position.

The driving member may drive the glass member to move up and down along a preset axis.

The first reflection plate and the second reflection plate may be located at opposite sides of the transmission area.

The electronic device may further include: a position setting unit configured to dispose the glass member to the extended position based on a photographing request; and an operation execution unit configured to control the camera of the electronic device to capture a photograph based on incident light originating from the second side, wherein the incident light is obtained by reflecting the light in front of the glass member by the first reflection plate and the second reflection plate.

The position setting unit may be further configured to, in response to receiving a photographing request, determine a type of the photographing request; and dispose the glass member to the extended position when the type of the photographing request is a preset type.

The position setting unit may be further configured to: determine whether a current position of the glass member is the extended position; and responsive to the photographing request being a preset type, move the glass member to the extended position when the current position of the glass member is not the extended position.

According to the embodiments of the present disclosure, for a method of operating an electronic device is provided, wherein the electronic device includes a processor, a camera, a driving member, and a glass member, wherein the glass member includes a reflection area comprising a first reflection plate and a second reflection plate. The method includes: disposing, by the driving member, the glass member to an extended position based on a photographing request; and controlling, by the processor, the camera of the electronic device to capture incident light incident to the camera, wherein the incident light originates from behind a facing direction of the camera, and is obtained by reflecting the light in front of the glass member by the first reflection plate and the second reflection plate.

The disposing the glass member to an extended position based on a photographing request may include: in response to receiving a photographing request, determining a type of the photographing request; and disposing the glass member to the extended position when the type of the photographing request is a preset type.

The disposing the glass member to the extended position may further include: determining whether the current position of the glass member is the extended position; and moving the glass member to the extended position when the current position of the glass member is not the extended position.

According to the exemplary embodiments of the present disclosure, a photographing device for an electronic device is provided, wherein the electronic device includes a glass member having a reflection area including a first reflection plate and a second reflection plate, and the photographing includes: a position setting unit configured to dispose the glass member to a extended position based on a photographing request; and an operation execution unit configured to capture a photograph based on incident light to a camera, wherein the incident light is obtained by reflecting the light in front of the glass member by the first reflection plate and the second reflection plate.

The position setting unit may be configured to, responsive to receiving a photographing request, determine the type of the photographing request; and dispose the glass member to the extended position when the type of the photographing request is a preset type.

The position setting unit may be configured to determine whether the current position of the glass member is the extended position; and move the glass member to the extended position when the current position of the glass member is not the extended position.

According to embodiments of the present disclosure, a computer readable storage medium storing instructions is provided, characterized in that the instructions, when being executed by at least one processor, cause the at least one processor to execute the methods described herein.

According to the embodiments of the present disclosure, a computing device includes: at least one processor; and at least one memory which stores computer executable instructions, wherein the computer executable instructions, when being executed by the at least one processor, cause the at least one processor to execute the methods described herein.

According to embodiments of the present disclosure, there provides a computer program product, wherein instructions in the computer program product can be executed by a processor of the computer device to complete the photographing method for the electronic device according to the embodiments of the present disclosure.

The electronic device according to the embodiments of the present disclosure includes: a camera; a glass member including a reflection area, wherein the reflection area includes a first reflection plate and a second reflection plate; and a processor configured to control the glass member to switch between a default first position and an extended second position, wherein when the glass member is in the first position, the light in front of the camera is not blocked by the reflection area, and when the glass member is in the second position, the light in front of the camera is blocked by the reflection area, and the reflection area forms a periscope with the camera by the first reflection plate and the second reflection plate, so that by adopting a periscope arrangement, the user can take photos in both the front and rear directions of the electronic device with one camera of the electronic device.

According to the photographing method and device for the electronic device according to the embodiments of the present disclosure, by first setting the glass member to an extended position based on a photographing request, then controlling the camera of the electronic device to perform a photographing command (e.g., capture a photo) based on the incident light incident to the camera, wherein the incident light is obtained by reflecting the light in front of the glass member by the first reflection plate and the second reflection plate, so that it is possible to take photos in the rear direction of the camera, such as from a display facing side of the electronic device.

### BRIEF DESCRIPTION OF DRAWINGS

The present disclosure will be more clearly understood from the following detailed description, taken in conjunction with the accompanying drawings, in which:

FIG. 1 is a block diagram of the electronic device according to an embodiment of the present disclosure;

FIG. 2 is a schematic diagram of the glass member 102 in a first position according to an embodiment of the present disclosure;

FIG. 3 is a schematic diagram of the glass member 102 in a second position according to an embodiment of the present disclosure;

FIG. 4 is a schematic diagram of the positional relationship between the camera 101 and the glass member 102 when the glass member 102 is in the first position according to an embodiment of the present disclosure;

FIG. 5 is a schematic diagram of the positional relationship between the camera 101 and the glass member 102 when the glass member 102 is in the second position according to an embodiment of the present disclosure;

FIG. 6 is a flow chart of the photographing method for the electronic device according to an embodiment of the present disclosure;

FIG. 7 is a block diagram of the photographing device for the electronic device according to an embodiment of the present disclosure; and

FIG. 8 is a schematic diagram of the computing device according to an embodiment of the present disclosure.

### DETAILED DESCRIPTION OF THE EMBODIMENTS

Hereinafter, embodiments of the present disclosure will be described in detail with reference to the accompanying drawings. Like reference numbers and symbols will refer to like components.

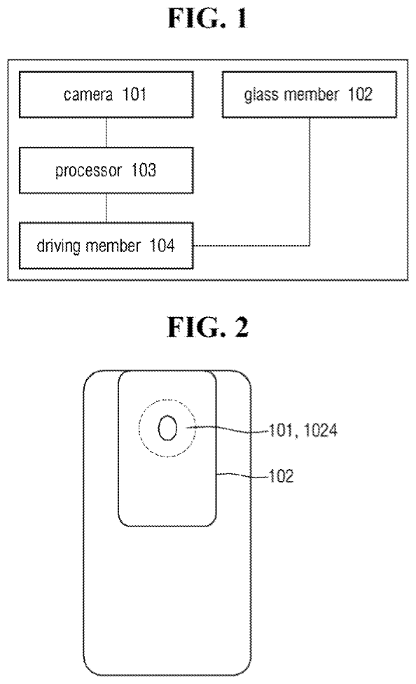

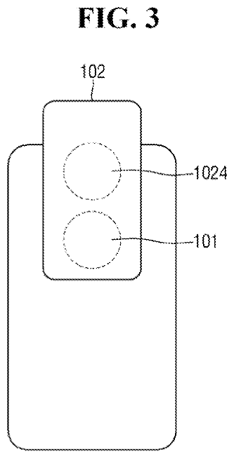

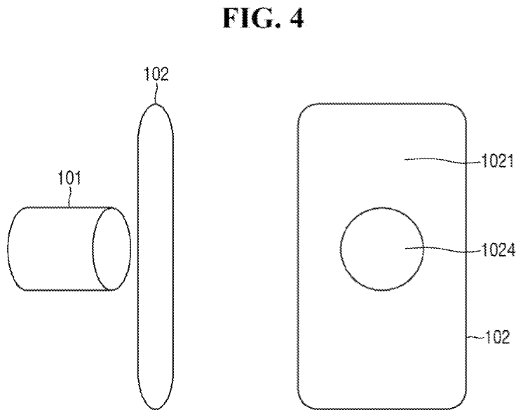

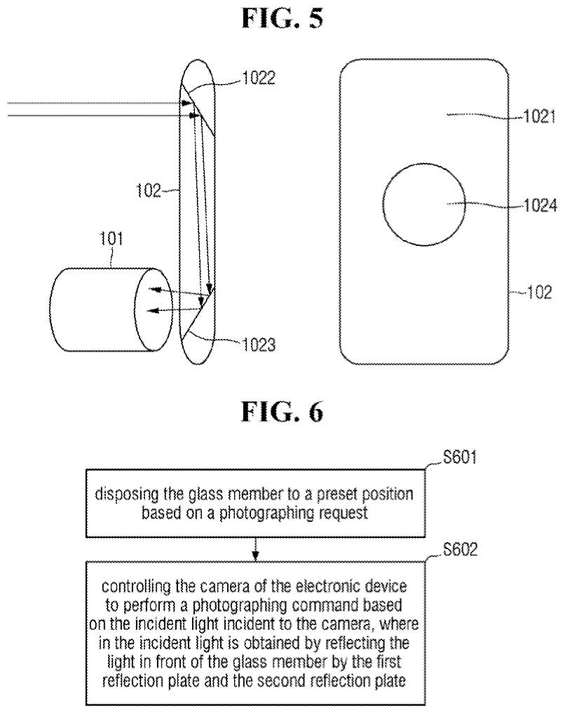

FIG. 1 is a block diagram of the electronic device according to an embodiment of the present disclosure. FIG. 2 is a schematic diagram of the glass member 102 in a first position according to an embodiment of the present disclosure. FIG. 3 is a schematic diagram of the glass member 102 in a second position according to an embodiment of the present disclosure. FIG. 4 is a schematic diagram of the positional relationship between the camera 101 and the glass member 102 when the glass member 102 is in the first position according to an embodiment of the present disclosure. FIG. 5 is a schematic diagram of the positional relationship between the camera 101 and the glass member 102 when the glass member 102 is in the second position according to an embodiment of the present disclosure.

Referring to FIG. 1, the electronic device includes a camera 101, a glass member 102, and a processor 103. The electronic device may further include a driving member 104. The driving member 104 may, for example, drive moment of the glass member 102. Here, the camera 101 may include a plurality of cameras, and the present disclosure does not limit the number of cameras. Although only one camera is shown in FIG. 2 to FIG. 5, at least one embodiment of the present disclosure includes a plurality of cameras.

The glass member 102 includes a reflection area 1021. Referring to FIG. 5, the reflection area 1021 includes a first reflection plate 1022 and a second reflection plate 1023.

In a configuration of the electronic device in which the reflection area 1021 does not receive light (e.g., when the reflection area 1021 is blocked or obscured), the light in front of the camera 101 directly enters the camera 101. In configurations where reflection area 1021 does receive light, the light incident on the reflection area 1021 is reflected by the reflection area 1021 and enters the camera 101. In this way, one camera of the electronic device may photograph both the front and rear directions of the electronic device.

The processor 103 may be a general purpose processor (for example, a CPU of the electronic device), or may be a special purpose processor that is not a part of the CPU of the electronic device. The processor 103 may be configured to control the glass member 102 to switch between a first position and a second position, thereby switching between photographing in the two directions. As shown in FIG. 2, when the glass member 102 is in the first position, the glass member 102 does not protrude from an upper edge of the electronic device. In this first position, the electronic device may have increased portability. As shown in FIG. 3, when the glass member 102 is in the second position, the glass member 102 protrudes from the upper edge of the electronic device to receive the light behind the camera 101.

When the glass member 102 is in the first position, the light in front of the camera 101 is not blocked by the reflection area 1021, such that light in front of the camera 101 directly enters the camera 101. In addition, when the glass member 102 is in the first position, the reflection area 1021 does not receive light. For example, when the glass member 102 is in the first position, the reflection area 1021 directly faces and is adjacent to the electronic device. When the glass member 102 is in the second position, the light in front of the camera 101 is blocked by the reflection area 1021, and the reflection area 1021 forms a periscope with the camera 101 by the first reflection plate 1022 and the second reflection plate 1023, so that light in front of the camera 101 (e.g., light coming onto a back side of the electronic device) cannot enter the camera 101, but the light behind the camera 101 (e.g., light coming onto a front side of the electronic device) enters the camera 101 by the periscope, so that photographing in both the front and rear directions of the electronic device is implemented by one camera of the electronic device.

In an embodiment of the present disclosure, the glass member 102 may also include a transmission area 1024. The transmission area 1024 does not include an opaque coating so that light in front of the camera 101 may be transmitted into the camera 101.

The left side of FIG. 4 is a side view that illustrates the positional relationship between the camera 101 and the glass member 102 when the glass member 102 is in the first position. The right side of FIG. 4 is a front view that illustrates the positional relationship between the camera 101 and the glass member 102 when the glass member 102 is in the first position. Combining the side view on the left side of FIG. 4 and the front view on the right side of FIG. 4, it can be seen that the transmission area 1024 overlaps with the position of the camera 101 when the glass member 102 is in the first position. Accordingly, the camera 101 may receive light from behind the electronic device, and may photograph scenes from behind the electronic device.

The left side of FIG. 5 is a side view that illustrates the positional relationship between the camera 101 and the glass member 102 when the glass member 102 is in the second position. The right side of FIG. 5 is a front view that illustrates the positional relationship between the camera 101 and the glass member 102 when the glass member 102 is in the second position. Combining the side view on the left side of FIG. 5 and the front view on the right side of FIG. 5, it can be seen that the transmission area 1024 does not overlap with the position of the camera 101 when the glass member 102 is in the second position. Accordingly, the camera 101 does not receive light from behind the electronic device, and instead receives light via the periscope structure from the front of the electronic device, and may photograph scenes from in front of the electronic device.

In an embodiment of the present disclosure, the first reflection plate 1022 and the second reflection plate 1023 may be located at two sides of the transmission area 1024. As shown in FIG. 5, the first reflection plate 1022 and the second reflection plate 1023 may be located at the upper side and the lower side of the transmission area 1024, respectively. In this case, when the glass member 102 is in the second position, the light reflected by the first reflection plate 1022 passes through the transmission area 1024 and to the second reflection plate 1023, as shown in FIG. 5.

In the embodiment of the present disclosure, when the glass member 102 is in the first position, the light in front of the camera 101 is incident to the camera 101 and passes through the transmission area 1024, allowing the photography of scenes in front of the camera 101.

In the embodiment of the present disclosure, when the glass member 102 is in the second position, as shown in FIG. 5, the light behind the camera 101 is incident to the camera 101 from the reflection of the first reflection plate 1022 and the second reflection plate 1023, allowing the photography of scenes in the rear direction of the camera 101. For example, a periscope composed of the first reflection 1022, the second reflection 1023, and the camera 101, allows photographing of scenes behind the camera 101. In some embodiments, this direction (the rear direction of the camera) is a display direction of the electronic device.

In the embodiment of the present disclosure, the reflection area 1021 may include an opaque coating to block light in front of the camera 101.

In the embodiment of the present disclosure, the electronic device may further include a driving member 104 for driving the glass member 102 to move according to the control of the processor 103, so that the glass member 102 is switched between the first position and the second position.

In the embodiment of the present disclosure, the driving member 104 may drive the glass member 102 to move up and down along a predetermined direction. For example, the driving member 104 may drive the glass member 102 to the first position and the second position, where the first position is lower than the second position, so that when the glass member 102 is in the second position, the light behind the camera 101 is received by the reflection of the reflection area 1021. For example, the electronic device may be in the first position when not taking a preset type of photographing (e.g., the first position may be a default position), and the driving member 104 lifts the glass member 102 from the first position to the second position when the preset type of photographing is required.

According to the electronic device according to the embodiment of the present disclosure, the glass member 102 needs to be lifted only when photographing in one of the directions, and the glass member 102 needs not be lifted when photographing the other direction. Accordingly, the glass member 102 may remain in the first, non-lifted position until necessary so as to be easily carried.

FIG. 6 is a flow chart of the photographing method for the electronic device according to an embodiment of the present disclosure.

The electronic device includes a glass member having a reelection area including a first reflection plate and a second reflection plate.

Referring to FIG. 6, in step S601, the glass member is disposed to a preset position based on a photographing request. For example, the present position may refer to the second position as described herein.

In the embodiment of the present disclosure, when the glass member (e.g., the glass member 102 in FIG. 1) is disposed to a preset position based on a photographing request, the type of the photographing request may be determined first in response to receiving the photographing request, and then the glass member may be disposed to a preset position when the type of the photographing request is a preset type. Here, the preset type may be a type that shoots the rear of the camera; e.g., towards a side of the electronic device opposite to which the camera 101 faces and is disposed. In addition, when the type of the photographing request is not the preset type, the position of the glass member may not be so disposed.

The glass member may include a reflection area and a transmission area. The glass member may have a first position and a second position. The preset position may be the second position. When the glass member is in the first position, the light in front of the camera of the electronic device is incident to the camera of the electronic device through the transmission area, so that the light in front of the camera of the electronic device is not blocked by the reflection area. In this first position, the reflection area of the glass member may receive no light; for example, the reflection area may face a backplate of the electronic device. When the glass member is in the second position, the light in front of the camera of the electronic device is blocked by the reflection area of the glass member, and the reflection area of the glass member and the camera form a periscope, so that the light in front of the camera of the electronic device cannot enter the camera, while the light behind the camera (e.g., from a display direction of the electronic device) enters the camera by the periscope. In this way, by switching the position of the glass member between the first position and the second position, photographing in both the front and rear directions of the electronic device is implemented by one camera of the electronic device. When the glass member is in the second position, the light behind the camera of the electronic device is incident to the camera by the reflection of the first reflection plate and the second reflection plate.

In the embodiment of the present disclosure, when the glass member is disposed to the preset position, it may be first determined whether the current position of the glass member is the preset position (e.g., the second position), and when the current position of the glass member is not the preset position, the glass member is moved to the preset position. In addition, when the current position of the glass member is the preset position, and the request is for a preset type of photography, the glass member is not moved.

For example, given a request for the preset type, when the current position of the glass member is not the preset position, the driving member of the electronic device may be controlled to move the glass member to the preset position. When the current position of the glass member is the preset position, the glass member does not need to be moved, and the position of the glass member already satisfies the requested photographing conditions.

In step S602, the camera of the electronic device is controlled to execute a photographing command based on incident light incident to the camera. Here, the incident light is obtained by reflecting the light in front of the glass member by the first reflection plate and the second reflection plate.

According to the photographing method for the electronic device according to the embodiment of the present disclosure, the user can take photos in both the front and rear directions of the electronic device with one camera of the electronic device. Since one camera can receive light from two directions, the images taken in the two directions can have similar photographing effects, such as optical characteristics and exposures as determined by the camera's configuration.

In addition, according to the embodiments of the present disclosure, a computer-readable storage medium having a computer program stored thereon is provided, and when the computer program is executed, a photographing method for the electronic device according to the embodiments of the present disclosure is implemented.

In the embodiments of the present disclosure, the computer-readable storage medium may carry one or more programs that, when executed, may implement the following steps: disposing the glass member to a preset position (e.g., a second position, or an extended position) based on a photographing request; and controlling the camera of the electronic device to perform a photographing command based on the incident light incident to the camera, wherein the incident light is obtained by reflecting the light in front of the glass member by the first reflection plate and the second reflection plate, wherein the electronic device includes a glass member having a reflection area including a first reflection plate and a second reelection plate.

The computer-readable storage medium can be, for example, but not limited to, an electrical, magnetic, optical, electromagnetic, infrared, or semiconductor system, apparatus or device, or any combination of the above. More specific examples of computer-readable storage medium may include, but are not limited to: electrical connections with one or more wires, portable computer disks, hard disks, random access memory (RAM), read only memory (ROM), erasable programmable read only memory (EPROM or flash memory), optical fiber, portable compact disk read only memory (CD-ROM), optical storage devices, magnetic storage devices, or any suitable combination of the above. In embodiments of the present disclosure, a computer-readable storage medium may be any tangible medium that contains or stores a computer program that can be used by or in conjunction with an instruction execution system, apparatus, or device. The computer program contained on the computer-readable storage medium may be transmitted using any appropriate medium, including but not limited to: wire, fiber optic cable, RF (radio frequency), etc., or any suitable combination of the above. The computer-readable storage medium may be included in any device; it may also exist alone without being incorporated into the device.

In addition, according to embodiments of the present disclosure, there also provides a computer program product, wherein instructions in the computer program product can be executed by a processor of the computer device to complete the photographing method for the electronic device according to the embodiments of the present disclosure.

The aforementioned programs may include software implemented on a circuit such as a processor. Software may include code to implement aspects of the present disclosure. Software may be stored in a non-transitory computer-readable medium such as system memory or other memory. In some cases, the software may not be directly executable by the processor but may cause a computer (e.g., when compiled and executed) to perform functions described herein. For example, the programs and software described herein may include code to interact with hardware components, such as the driving member 104, the camera 101, and others, so as to execute a photographing operation in the first or second positions.

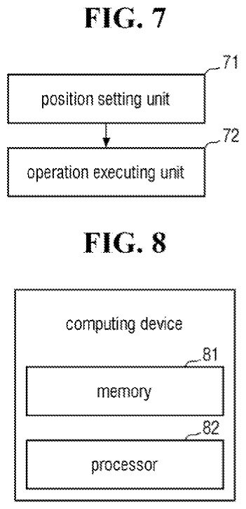

The photographing method for the electronic device according to the embodiments of the present disclosure has been described above in conjunction with FIGS. 1-6. Hereinafter, the photographing device for the electronic device and the unit thereof according to the embodiments of the present disclosure will be described with reference to FIG. 7.

FIG. 7 is a block diagram of the photographing device for the electronic device according to an embodiment of the present disclosure.

Referring to FIG. 7, a photographing device for the electronic device includes a position setting unit 71 and an operation performing unit 72. Here, the electronic device includes a glass member having a reflection area, the reflection area include a first reflection plate and a second reflection plate.

A position setting unit 71 is configured to dispose the glass member to a preset position based on a photographing request. For example, the position setting unit 71 may determine which position the glass member is currently in, and operably control another unit such as the driving member 104 to dispose the glass member to a preset position based on the determined position.

In the embodiments of the present disclosure, the position setting unit 71 may be configured to in response to receiving a photographing request, determining the type of the photographing request; and disposing the glass member to the preset position when the type of the photographing request is a preset type.

In the embodiments of the present disclosure, the position setting unit 71 may be configured to determine whether the current position of the glass member is the preset position; and move the glass member to the preset position when the current position of the glass member is not the preset position.

An operation execution unit 72 is configured to control the camera of the electronic device to perform a photographing operation based on the incident light incident on the camera. For example, the operation execution unit 72 may control the camera of the electronic device to capture a photograph based on the incident light. Here, the incident light may come from reflecting the light in front of the glass member by the first reflection plate and the second reflection plate.

The position setting unit 71 and the operation execution unit 72 may be implemented in hardware, software, or a combination of hardware and software. For example, the position setting unit 71 may be implemented by a processor which is connected to one or more sensors. The operation execution unit 72 may be implemented by a processor, and may be connected to various components such as a digital image sensor, motor, etc.

The photographing device for the electronic device according to the embodiments of the present disclosure has been described above in conjunction with FIG. 7. Next, a computing device according to the embodiment of the present disclosure will be described in conjunction with to FIG. 8.

FIG. 8 is a schematic diagram of the computing device according to an embodiment of the present disclosure.

Referring to FIG. 8, a computing device 8 according to the embodiment of the present disclosure includes a memory 81 and a processor 82, and the memory 81 stores a computer program. When the computer program is executed by the processor 82, a photographing method for the electronic device according to the embodiments of the present disclosure is implemented.

In the embodiments of the present disclosure, when the computer program is executed by the processor 82, the following steps may be implemented: disposing the glass member to a preset position based on a photographing request; and controlling the camera of the electronic device to perform a photographing command based on the incident light incident to the camera, wherein the incident light is obtained by reflecting the light in front of the glass member by the first reflection plate and the second reflection plate.

A processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof). In some cases, the processor is configured to operate a memory array using a memory controller. In other cases, a memory controller is integrated into the processor. In some cases, the processor is configured to execute computer-readable instructions stored in a memory to perform various functions. In some embodiments, a processor includes special purpose components for modem processing, baseband processing, digital signal processing, or transmission processing.

Computing devices in embodiments of the present disclosure may include, but are not limited to, devices such as mobile phones, notebook computers, PDAs (personal digital assistants), PADs (tablet computers), desktop computers, and the like. The computing device shown in FIG. 8 is only an example, and does not impose any limitation on the function and scope of use of the embodiments of the present disclosure.

The photographing method and device for the electronic device according to the embodiments of the present disclosure have been described above with reference to FIGS. 1-8. However, it should be understood: the photographing device for the electronic device and the unit thereof shown in FIG. 7 may be respectively configured as software, hardware, firmware or any combination of the above to perform specific functions, and the computing device shown in FIG. 8 is not limited to including the above shown components, but some components may be added or deleted according to different embodiment designs, and the above components may also be combined.

According to the embodiments of the present disclosure, the electronic device includes: a camera, a glass member including a reflection area, wherein the reflection area includes a first reflection plate and a second reflection plate, and a processor configured to control the glass member to switch between a first position and a second position. When the glass member is in the first position, the light in front of the camera is not blocked by the reflection area, and when the glass member is in the second position, the light in from of the camera is blocked by the reflection area. The reflection area forms a periscope with the camera by the first reflection plate and the second reflection plate, so that by adopting a periscope arrangement, the user can take photos in both the front and rear directions of the electronic device with one camera of the electronic device.

According to the photographing method and device for the electronic device according to the embodiments of the present disclosure, by first setting the glass member to a preset position based on a photographing request, then controlling the camera of the electronic device to perform a photographing command based on the incident light incident to the camera, wherein the incident light is obtained by reflecting the light in front of the glass member by the first reflection plate and the second reflection plate, it is possible to take photos in the rear direction of the camera.

Although the present disclosure has been specifically shown and described with reference to the embodiments thereof, those skilled in the art should understand that various changes of the forms and details can be made without departing from the spirit and scope of the present disclosure as defined by the claims.

What is claimed is:

1. An electronic device, comprising:
a first side, and a second side opposite the first side;
a camera disposed on the first side;
a glass member comprising a reflection area, wherein the reflection area comprises a first reflection plate and a second reflection plate; and
a processor configured to control the glass member to switch between a default position and an extended position,
wherein, when the glass member is in the default position, light incident on the camera from the first side passes through the reflection area to the camera; and
when the glass member is in the extended position, light incident on the camera from the first side is blocked by the reflection area, and the reflection area forms a periscope with the first reflection plate and the second reflection plate to redirect light from the second side to the camera.

2. The electronic device of claim 1, wherein the glass member further comprises a transmission area.

3. The electronic device of claim 2, wherein, when the glass member is in the default position, the light incident from the first side passes through the transmission area to the camera.

4. The electronic device of claim 3, wherein the reflection area comprises an opaque coating.

5. The electronic device of claim 3, wherein, when the glass member is in the extended position, the light from the second side of the electronic device is incident to the camera by the reflection oldie first reflection plate and the second reflection plate.

6. The electronic device of claim 1, further comprising a driving member configured to move glass member to the default position or the extended position in response to a control signal from the processor.

7. The electronic device of claim 1, wherein the driving member drives the glass member to move along a preset axis.

8. The electronic device of claim 2, wherein the first reflection plate and the second reflection plate are located at opposite sides of the transmission area.

9. A method of operating an electronic device, wherein the electronic device comprises a processor, a camera, a driving member, and a glass member, wherein the glass member includes a reflection area comprising a first reflection plate and a second reflection plate, the method comprising:
disposing, by the driving member, the glass member to an extended position based on a photographing request; and
controlling, by the processor, the camera of the electronic device to capture incident light incident to the camera, wherein the incident light originates from behind a facing direction of the camera, and is obtained by reflecting the light in front of the glass member by the first reflection plate and the second reflection plate.

10. The method of claim 9, wherein the disposing the glass member to the extended position based on a photographing request comprises:
in response to receiving a photographing request, determining a type of the photographing request; and
disposing the glass member to the extended position when the type of the photographing request is a preset type.

11. The method of claim 10, wherein the disposing the glass member to the extended position further comprises:
determining whether a current position of the glass member is the extended position; and
responsive to the photographing request being a preset type, moving the glass member to the extended position when the current position of the glass member is not the extended position.

12. A photographing device for an electronic device, wherein the electronic device comprises a glass member having a reflection area comprising a first reflection plate and a second reflection plate, comprising:
a position setting unit configured to dispose the glass member to an extended position based on a photographing request; and
an operation execution unit configured to capture a photograph based on incident light to a camera, wherein the incident light is obtained by reflecting the light in front of the glass member by the first reflection plate and the second reflection plate.

13. The photographing device of claim 12, wherein the position setting unit is configured to:
in response to receiving a photographing request, determine a type of the photographing request; and
dispose the glass member to the extended position when the type of the photographing request is a preset type.

14. The photographing device of claim 13, wherein the position setting unit is configured to:
determine whether a current position of the glass member is the extended position; and
responsive to the photographing request being a preset type, move the glass member to the extended position when the current position of the glass member is not the extended position.
